(19) United States
(12) Patent Application Publication
(10) Pub. No.: US 2005/0091935 A1
(43) Pub. Date: May 5, 2005

(54) Window assembly and method for manufacturing the same

(75) Inventors: Katsuyuki Amano, Aichi (JP); Akihiro Suzuki, Aichi (JP); Tomoki Takeuchi, Aichi (JP)

Correspondence Address: OLIFF & BERRIDGE, PLC, P.O. BOX 19928, ALEXANDRIA, VA, 22320, US

(73) Assignee: TOKAI KOGYO CO., LTD., Obu-city (JP)

(21) Appl. No.: 10/937,348

(22) Filed: Sep. 10, 2004

(30) Foreign Application Priority Data
Sep. 18, 2003 (JP) 2003-325640

(51) Int. Cl. E06B 7/00; B60J 10/02

(52) U.S. Cl. 52/204.591

(57) ABSTRACT

A window assembly has a window pane formed from inorganic glass and a concealing member formed along a peripheral edge of the window pane. The concealing member is bonded to the window pane through an adhesive layer containing an acid-modified polyolefin resin or an acid-modified olefin-styrene copolymer resin as a main component. The concealing member is formed in such a manner that a forming material mainly containing an olefin-based thermoplastic elastomer material or a styrene-based thermoplastic elastomer material is heated and molten, and the molten forming material is brought into pressure contact with the window pane having the adhesive layer formed thereon in advance, and then cooled and solidified.

### BACKGROUND OF THE INVENTION

1. Field of the Invention

The present invention relates to a window assembly which is in use attached to a window opening edge of a body to be attached, such as a vehicle.

2. Description of the Related Art

There is a known window assembly including an inorganic glass window pane and a concealing member (also referred to as “frame”, “molding”, “gasket”, etc., which will be hereinafter generically referred to as “concealing member”) integrally and fixedly attached to the window pane along a peripheral edge of the window pane. Such a window assembly is in use attached to a window opening edge of a body to be attached such as a vehicle, a building or a work piece. The concealing member is formed from a softer material (synthetic resin, material analogous to the synthetic resin, or the like) than the window pane so as to have a function of concealing a gap between the window pane and the body to be attached.

As such a window assembly, there is a window assembly (also referred to as “module window” or “modular window”) in which a frame (concealing member) is formed integrally with and along a peripheral edge of a transparent window pane by injection molding of a soft or semi-hard vinyl chloride resin. JP-A-2-60722 discloses such a kind of window assembly.

### SUMMARY OF THE INVENTION

Recently, a concealing member formed from a material substituted for a vinyl chloride resin has been demanded from the viewpoint of consideration to environment or the like. It can be conceived that thermoplastic elastomer materials (hereinafter also referred to as “TPE”) are used as such substitute materials. Of them, a concealing member mainly formed from an olefin-based (olefinic) thermoplastic elastomer (hereinafter also referred to as “TPO”) is preferably used from the viewpoint of easiness of availability and reduction in weight, and a concealing member mainly formed from a styrene-based thermoplastic elastomer (hereinafter also referred to as “TPS”) is preferably used from the viewpoint of easiness of availability. However, TPE has generally lower adhesion to inorganic glass than a vinyl chloride resin. For this reason, when TPE is used for a concealing member of a module window, adhesion between the inorganic glass window pane and the concealing member is reduced or even absent. Accordingly, it is difficult to use TPE for the concealing member.

Therefore, an object of the invention is to provide a window assembly having a concealing member mainly containing TPE (particularly, TPO or TPS) and formed to have proper adhesion to a peripheral portion of an inorganic glass window pane. Another object of the invention is to provide a suitable method for manufacturing the window assembly.

A first aspect of the invention relates to a window assembly to be attached to a window opening edge of a body to be attached. The window assembly has an inorganic glass window pane having a front surface and a rear surface, and a concealing member formed integrally with the window pane along a peripheral edge of the window pane. When the window assembly according to the invention is attached to a predetermined position of the window opening edge, a space between the peripheral edge of the window pane and the window opening edge is concealed by the concealing member. In the peripheral edge of the window pane and in a portion where the concealing member is formed, an adhesive layer containing one of an acid-modified polyolefin resin and an acid-modified olefin-styrene copolymer resin as a main component is formed in advance. The concealing member includes a base portion which is formed from a base portion forming material mainly containing one of an olefin-based thermoplastic elastomer material and a styrene-based thermoplastic elastomer material, and which is bonded to the window pane. The base portion is typically formed as follows. That is, the base portion forming material heated and molten is pressed against the window pane. In that state, the molten base portion forming material is bonded to the window pane through the adhesive layer, and solidified by cooling. The concealing member further includes a projection portion formed from a projection portion forming material mainly containing a thermoplastic elastomer material and integrally with the base portion. The projection portion protrudes from the base portion toward the window opening edge. When the window assembly is attached to the predetermined position, the projection portion is elastically deformed and brought into elastic contact (elastic pressure contact) with the window opening edge.

According to the first aspect of the invention, it is possible to obtain the following effect. That is, a window assembly in which a base portion of a concealing member mainly formed from an olefin-based thermoplastic elastomer material or a styrene-based thermoplastic elastomer material is firmly bonded to an inorganic glass window pane can be provided.

According to a second aspect of the invention, in the window assembly defined in the first aspect, a roughened layer having a surface rougher than the front surface of the window pane is formed in at least a peripheral edge of the rear surface of the window pane, at least a part of the adhesive layer is formed on the roughened layer, and the base portion of the concealing member is bonded to the window pane through the adhesive layer. According to the window assembly in the second aspect, in addition to the effect of the window assembly in the first aspect, it is possible to obtain the following effect. That is, a window assembly in which bonding strength of a concealing member is enhanced due to an anchor effect can be provided.

According to a third aspect of the invention, in the window assembly defined in the first or second aspect, at least a part of an end surface of the window pane is roughened by grinding, the adhesive layer is formed in a portion including the roughened end surface, and the base portion of the concealing member is bonded to the window pane through the adhesive layer. According to the window assembly in the third aspect, in addition to the effect of the window assembly in the first or second aspect, it is possible to obtain the following effect. That is, a window assembly having a concealing member bonded more firmly can be provided.

According to a fourth aspect of the invention, in the window assembly defined in any one of the first to third aspects, the base portion forming material further contains an inorganic filler. According to the window assembly in the fourth aspect, in addition to the effect of the window assembly in any one of the first through the third aspects, it is possible to obtain the following effect. That is, a window assembly having a concealing member bonded more firmly can be provided.

According to a fifth aspect of the invention, in the window assembly defined in any one of the first to fourth aspects, a periphery of the window pane has linear portions and corner portions, the concealing member is formed continuously in an area covering the linear portions and the corner portions, and the concealing member is formed into such a shape that the projection portion is more displaced toward a surface center of the window pane in the corner portions than in the linear portions. According to the window assembly in the fifth aspect, in addition to the effect of the window assembly in any one of the first through the fourth aspects, it is possible to obtain the following effect. That is, compression winkles hardly occur in the projection portion at the corner portions when the window assembly is attached to the body to be attached.

According to a sixth aspect of the invention, in the window assembly defined in any one of the first to fifth aspects, the acid-modified polyolefin resin is a carboxyl-modified polyolefin resin or an acrylic-modified polyolefin resin. According to the window assembly in the sixth aspect, in addition to the effect of the window assembly in any one of the first through the fifth aspects, it is possible to obtain the following effect. That is, a window assembly having a concealing member bonded more firmly can be provided.

According to a seventh aspect of the invention, in the window assembly defined in any one of the first to fifth aspects, the acid-modified olefin-styrene copolymer resin is a carboxyl-modified olefin-styrene copolymer resin or an acrylic-modified olefin-styrene copolymer resin. According to the window assembly in the seventh aspect, in addition to the effect of the window assembly in any one of the first through the fifth aspects, it is possible to obtain the following effect. That is, a window assembly having a concealing member bonded more firmly can be provided.

An eighth aspect of the invention relates to a method for manufacturing a window assembly including an inorganic glass window pane and a concealing member formed along a peripheral edge of the window pane. The manufacturing method includes the step of preparing the window pane in which an adhesive layer is formed in a portion where the concealing member is to be formed. The adhesive layer typically contains one of an acid-modified polyolefin resin and an acid-modified olefin-styrene copolymer resin as a main component. The manufacturing method may also include the steps of: setting the window pane including the adhesive layer in an injection mold; closing the mold so that the window pane is fixed in the mold with the peripheral edge of the window pane being at least partially exposed in a cavity of the mold, and forming the cavity corresponding to a shape of the concealing member in the inside of the mold; filling the cavity with a forming material by injection through an injection gate of the mold under a predetermined injection pressure while the forming material mainly containing one of an olefin-based thermoplastic elastomer material and a styrene-based thermoplastic elastomer material is heated and molten, so that the concealing member is formed and bonded to the window pane through the adhesive layer; and cooling and solidifying the forming material, and opening the mold so as to extract the window assembly from the mold, the window assembly having the concealing member integrally bonded to the peripheral edge of the window pane.

According to the manufacturing method in the eighth aspect, it is possible to obtain the following effect. That is, a window assembly in which a concealing member mainly formed from an olefin-based thermoplastic elastomer material or a styrene-based thermoplastic elastomer material is firmly bonded to an inorganic glass window pane can be manufactured.

A ninth aspect of the invention relates to another method for manufacturing a window assembly including an inorganic glass window pane and a concealing member formed along a peripheral edge of the window pane. The manufacturing method may include the step of forming an adhesive layer on at least a portion of the window pane where the concealing member is to be formed. Typically, the adhesive layer thus formed contains one of an acid-modified polyolefin resin and an acid-modified olefin-styrene copolymer resin as a main component. The manufacturing method has the steps of: setting the window pane including the adhesive layer in an injection mold; closing the mold so that the window pane is fixed in the mold with the peripheral edge of the window pane being at least partially exposed in a cavity of the mold, and forming the cavity corresponding to a shape of the concealing member in the inside of the mold; heating and melting a forming material mainly containing one of an olefin-based thermoplastic elastomer material and a styrene-based thermoplastic elastomer material, and filling the cavity with the molten forming material by injection through an injection gate of the mold under a predetermined injection pressure so as to form the concealing member and bond the concealing member to the window pane through the adhesive layer; and solidifying and cooling the forming material, and opening the mold so as to extract the window assembly from the mold, the window assembly having the concealing member integrally bonded to the peripheral edge of the window pane.

According to the manufacturing method in the ninth aspect, it is possible to obtain the following effect. That is, a window assembly in which a concealing member formed from an olefin-based thermoplastic elastomer material or a styrene-based thermoplastic elastomer material is firmly bonded to an inorganic glass window pane can be manufactured. This manufacturing method is preferably used also in the case where the adhesive layer has a limited period to exert its function (adhesion performance) effectively. That is, the manufacturing method has a high degree of freedom to select a material (adhesive agent) to be used for forming the adhesive layer.

According to a tenth aspect of the invention, in the manufacturing method defined in the eighth or ninth aspect, a roughened layer having a surface rougher than a front surface of the window pane is formed at least in a peripheral edge of a rear surface of the window pane, and the adhesive layer is formed on the roughened layer. According to the manufacturing method in the tenth aspect, in addition to the effect of the manufacturing method in the eighth or ninth aspect, it is possible to obtain the following effect. That is, a window assembly having a concealing member bonded more firmly can be manufactured.

According to an eleventh aspect of the invention, in the manufacturing method defined in any one of the eighth to tenth aspects, the adhesive layer is formed from an adhesive agent containing one of an acid-modified polyolefin resin and an acid-modified olefin-styrene copolymer resin as a main component and applied onto at least one of (a) a periphery of one of surfaces of the window pane and an end surface of the window pane and (b) a periphery of the other surface of the window pane, and the concealing member is formed on the adhesive layer formed on one of the aforementioned surfaces. According to the manufacturing method in the eleventh aspect, in addition to the effect of the manufacturing method in any one of the eighth to the tenth aspects, it is possible to obtain the following effect. That is, a window assembly having a concealing member bonded more firmly can be manufactured.

According to a twelfth aspect of the invention, in the manufacturing method defined in any one of the eighth to eleventh aspects, the forming material is injected while at least a peripheral edge of the window pane set in the mold is heated to a temperature range higher than normal temperature. According to the manufacturing method in the twelfth aspect, in addition to the effect of the manufacturing method in any one of the eighth to eleventh aspects, at least one of the following effects can be obtained. That is, a window assembly having a concealing member bonded more firmly can be manufactured. Since thermal shock applied to the window pane when the forming material molten by heating is injected into the cavity can be relaxed, unexpected damage can be prevented from occurring in the window pane. In addition, the forming material can be prevented from being solidified due to sudden drop in temperature. Accordingly, the cavity can be filled properly in every corner with the forming material without giving any excessive flow resistance to the forming material and without needing any excessive injection pressure.

According to a thirteenth aspect of the invention, in the manufacturing method defined in the twelfth aspect, the concealing member is bonded to the window pane while the window pane as a whole is heated to a temperature range higher than normal temperature. In this manufacturing method, since the concealing member is bonded in the condition that the outer shape of the window pane is expanded by heating, both the window pane and the concealing member are contracted by cooling after the bonding of the concealing member. For this reason, a difference in contraction amount between the window pane and the concealing member can be reduced in comparison with that in the case where the concealing member is bonded to the window pane in a temperature range not higher than normal temperature. Accordingly, according to the manufacturing method in the thirteenth aspect, in addition to the effect of the manufacturing method in the twelfth aspect, it is possible to obtain the following effect. That is, stress generated between the window pane and the concealing member is reduced to thereby avoid occurrence of failure such as distortion or deformation in the window pane and/or the concealing member more effectively.

### BRIEF DESCRIPTION OF THE DRAWINGS

FIG. 1 is a schematic front view showing a window assembly according to a first embodiment;

FIG. 2 is a sectional view taken along line II-II in FIG. 1;

FIG. 3 is an explanatory view showing a method for manufacturing a window assembly according to the first embodiment;

FIG. 4 is an explanatory view showing a method for manufacturing a window assembly according to a second embodiment;

FIG. 5 is a schematic front view showing a window assembly according to a third embodiment;

FIG. 6 is a sectional view taken along line VI-VI in FIG. 5;

FIG. 7 is an explanatory view showing a method for injection-molding a molded piece according to a fourth embodiment;

FIG. 8 is an explanatory view showing a method for testing peel strength; and

FIG. 9 is an explanatory view showing a method for testing peel strength.

### DETAILED DESCRIPTION OF THE PREFFERED EMBODIMENTS

Preferred embodiments of the invention will be described below in detail. Incidentally, technical matters other than contents particularly described in the specification, if they are necessary matters for carrying out the invention, can be grasped as matters that may be designed by those skilled in the art based on the background art. The invention can be carried out on the basis of the technical contents disclosed in the specification and the drawings and technical common knowledge in this field.

At least a base portion (a portion to be bonded to a window pane) of a concealing member constituting a window assembly according to the invention is formed from a forming material mainly containing an olefin-based thermoplastic elastomer material or a styrene-based thermoplastic elastomer material.

Examples of hard segments (olefin components) of the olefin-based thermoplastic elastomer composing the forming material may include polyethylene (PE), polypropylene (PP), poly-1-pentene, etc. Of them, polyethylene and polypropylene are preferable and polypropylene is particularly preferable. Examples of soft segments (elastomer components) of the olefin-based thermoplastic elastomer may include ethylene-propylene copolymer (EPM) and ethylene-propylene-diene terpolymer (EPDM). Of them, EPDM is particularly preferable. As the hard segments, two or more kinds of polymers may be contained. The same thing can be applied to the soft segments. Particularly, an olefin-based thermoplastic elastomer containing polypropylene as its hard segment and EPM or EPDM as its soft segment is preferably used. For example, a forming material containing 5-45 parts (preferably 10-35 parts, more preferably 20-30 parts) of polypropylene, 20-60 parts (preferably 30-50 parts) of EPDM and a proper amount (e.g. 20-50 parts, preferably 30-40 parts) of a softener in mass ratio may be preferably used. Examples of commercially available products of TPO which can be preferably used as materials for forming the concealing member (at least the base portion of the concealing member) include “Santoprene (registered trademark)” available from Advanced Elastomer Systems Japan Ltd., “Milastomer (registered trademark)” available from Mitsui Chemicals, Inc. and “Thermorun” (trademark) available from Mitsubishi Chemical Corp.

As the styrene-based thermoplastic elastomer forming the forming material, a styrene block copolymer (SBC) containing a styrene block and an olefin block is preferable. For example, a styrene-butadiene-styrene block copolymer (SBS), a styrene-isoprene-styrene block copolymer (SIS), a styrene-ethylene-butylene-styrene block copolymer (SEBS, hydrogenated SBS), a styrene-ethylene-propylene-styrene block copolymer (SEPS, hydrogenated SIS), etc., can be used. Examples of commercially available products of SBC which can be preferably used as materials for forming the concealing member (at least the base portion of the concealing member) include “Actymer” (trademark) available from Rikentechnos Corp., “Sumiflex” (trademark) available from Advanced Plastics Compounds Company, and “Rabalon (registered trademark)” available from Mitsubishi Chemical Corp.

The material for forming at least the portion (base portion) of the concealing member to be bonded to the window pane may contain an organic or inorganic filler. An inorganic filler is preferably used. Examples of inorganic fillers include at least one kind of particulate inorganic filler selected from calcium carbonate, calcium silicate, magnesium silicate, carbon black, talc, clay, kaoline, silica, diatomaceous earth, mica powder, alumina, barium sulfate, aluminum sulfate, calcium sulfate, basic magnesium carbonate, molybdenum disulfide, glass beads, shirasu balloons, etc.; and a fibrous inorganic filler such as inorganic fiber such as carbon fiber, glass fiber, alumina fiber, silicon carbide fiber, inorganic whisker (e.g. basic magnesium sulfate whisker, potassium titanate whisker, and aluminum borate whisker), etc. Only one kind of these fillers may be used, or two or more kinds of fillers may be used together. For example, such inorganic filler(s) can be 1% to 50 mass % with respect to the total mass of the portion to be contained.

Incidentally, the portion (e.g. projection portion) of the concealing member other than the portion where the concealing member is bonded to the window pane may be formed from a forming material having substantially the same composition as that of the aforementioned base portion forming material, or may be formed from a forming material (e.g. forming material mainly containing TPE other than TPO or TPS) having a different composition from that of the aforementioned base portion forming material. From the viewpoint of easiness of manufacturing or the like, it is generally preferable that the base portion and the projection portion are integrally injection-molded as in embodiments which will be described later.

The adhesive layer contains an acid-modified polyolefin resin or an acid-modified olefin-styrene copolymer resin as a main component. Examples of the polyolefin resin may include a polyethylene resin, a polypropylene resin, a copolymer resin of ethylene and another α-olefin (at least one kind selected from propylene, 1-butene, 1-hexene, 4-methyl-1-pentene, etc.), and a copolymer resin of propylene and another α-olefin (at least one kind selected from 1-butene, 1-hexene, 4-methyl-1-pentene, etc.). Examples of the olefin-styrene copolymer resin may include a copolymer resin of an olefin-based monomer (ethylene, propylene, 1-butene, 1-hexene, 4-methyl-1-pentene, etc.) and a styrene-based monomer (styrene, a-methyl styrene, etc.). A typical example is a block copolymer resin of an olefin-based monomer and a styrene-based monomer. Incidentally, “resin” herein may include polimers exhibiting good rubber elasticity at normal temperature.

The expression “the polyolefin resin or the olefin-styrene copolymer resin is “acid-modified”” means that an acidic group (typically a carboxyl group) is formed. For example, the acid-modified resin can be obtained by graft-polymerizing unsaturated carboxylic acid into the aforementioned polyolefin resin or olefin-styrene copolymer resin. As the unsaturated carboxylic acid, at least one kind selected from acrylic acid, methacrylic acid, crotonic acid, isocrotonic acid, maleic acid, fumaric acid, itaconic acid, etc., can be used. Alternatively, an unsaturated carboxylic acid derivative (ester, anhydride, or the like) which can be transformed into a carboxyl group by a proper post treatment (hydrolysis etc.) may be used. For example, after acrylic ester and/or methacrylate ester is graft-polymerized, the ester can be hydrolyzed to generate a carboxyl group.

Examples of the acid-modified resin preferably used as a main component of the adhesive layer (adhesive agent) in the invention may include a so-called carboxyl-modified polyolefin resin, an acrylic-modified polyolefin resin, a carboxyl-modified olefin-styrene copolymer resin, and an acrylic-modified olefin-styrene copolymer resin. An example of a commercially available product of the material which can be used for forming the adhesive layer includes “Surflen (registered trademark)” available from Mitsubishi Chemical Corp. For example, “Surflen (registered trademark) P-1000”, “Surflen A-1000”, “Surflen E-2000”, “Surflen AP-343”, etc., can be used. Particularly, “Surflen (registered trademark) P-1000” and “Surflen AP-343” can be used preferably.

Incidentally, a theory for obtaining proper adhesion can be conceived as follows.

That is, when TPO and the acid-modified polyolefin resin adhesive agent are bonded to each other, the adhesive agent and the glass are bonded to each other due to hydrogen bond or ester linkage between a —H group in the adhesive agent and a —OH group in the glass activated by heating, while the adhesive agent and the concealing member are bonded to each other due to compatibility between the olefin component in the adhesive agent and the olefin component (e.g. PP component) of the concealing member. In this manner, it is conceived that the window pane formed from glass and the concealing member using TPO are bonded to each other properly.

When TPS and the acid-modified olefin-styrene copolymer resin adhesive agent are bonded to each other, the adhesive agent and the glass are bonded to each other due to hydrogen bond between a —H group in the adhesive agent and a —OH group in the glass activated by heating, while the adhesive agent and the concealing member are bonded to each other due to compatibility between the olefin component in the adhesive agent and the olefin component of the concealing member. In this manner, it is conceived that the window pane formed from glass and the concealing member using TPS are bonded to each other properly.

Although embodiments of the invention will be described below, the invention is not intended to limit its contents to the following embodiments.

### FIRST EMBODIMENT

The invention will be described on the case where the invention is applied to a back window of a car.

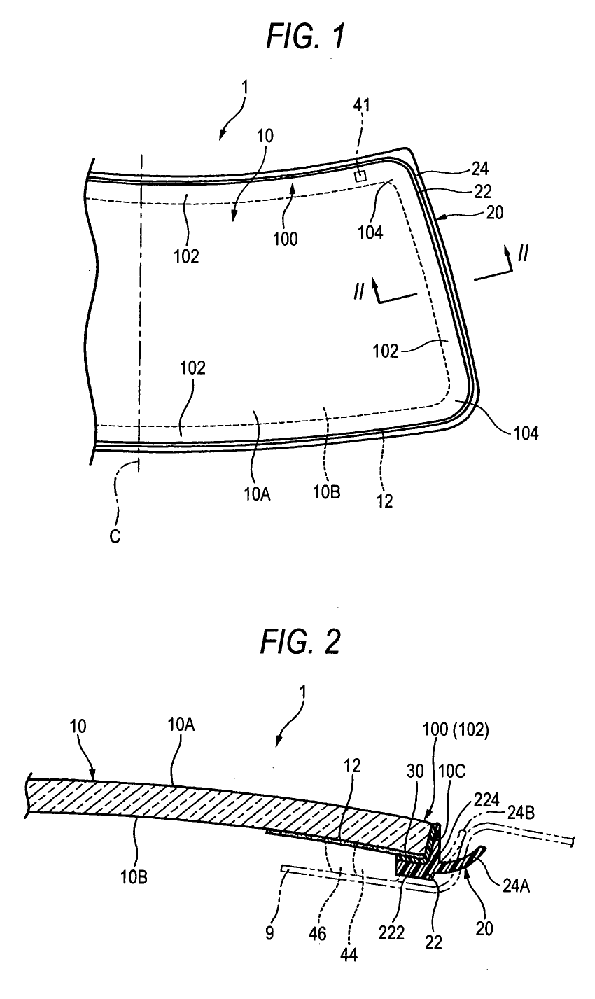

As shown in FIG. 1, a window assembly 1 for a back window according to this embodiment has a transparent window pane 10 including a front surface and a rear surface, and a concealing member 20 provided along a peripheral edge portion (peripheral edge) 100 of the transparent window pane 10. The window assembly 1 is formed to be substantially symmetrical about a line C shown in FIG. 1. The outer circumferential shape of the window pane 10 is roughly rectangular in front view. The outer circumferential shape of the window pane 10 has four linear portions 102 comparatively nearly linear and corner portions 104 located between adjacent ones of the nearly linear portions 102. In this embodiment, the concealing member 20 is formed on the whole circumference of the window pane 10. That is, the concealing member 20 is formed continuously in an area covering the linear portions 102 and the corner portions 104.

As shown in FIG. 2, the window pane 10 as a whole is formed into a curved shape so that its front surface 10A on the vehicle exterior side is convex and its rear surface 10B on the vehicle interior side is concave when the window pane 10 is attached to the car as a body to be attached. As the window pane 10, a general car rear glass window material (e.g. tempered glass having a plate thickness of about 3.0-3.5 mm) can be used.

A frit layer 12 formed in the rear surface 10B of the window pane 10 is fusion-bonded to a peripheral edge thereof. Since inorganic powder (typically glass powder) having a relatively high melting point is dispersed in the front surface (exposed surface) of the frit layer 12, the front surface of the frit layer 12 is a surface rougher than the other portion of the window pane 10 (i.e. the front surface 10A and the portion of the rear surface 10B where the frit layer 12 is not formed). The frit layer 12 is colored to be opaque. Typically, the frit layer 12 is colored in black. The frit layer 12 has a function as a blindfold over the rear side of the peripheral portion of the window pane 10 when viewed from the front surface of the window assembly 1. An end surface 10C of the window pane 10 is ground (ground by a grinder etc.) to be rougher than the front surface of the transparent portion of the window pane 10.

The concealing member 20 has a base portion 22 and a projection portion 24. The base portion 22 covers the peripheral edge portion 100 of the window pane 10 in the range of from the end surface (peripheral end surface) 10C to the rear surface 10B in the form of an almost L-shape in section. The projection portion 24 is formed to be thin and elastically deformable and to protrude outwardly from the base portion. An adhesive layer 30 is provided on the window pane rear surface 10B and the window pane end surface 10C in the portion where the window pane 10 will be covered with the base portion 22. Thus, the base portion 22 (concealing member 20) is bonded to the window pane 10 through the adhesive layer 30. In the portion where the frit layer 12 is formed, the adhesive layer 30 is formed on the frit layer 12. In this embodiment, the base portion 22 and the projection portion 24 are formed integrally by injection molding from a concealing member forming material mainly containing TPO. The adhesive layer 30 contains an acid-modified polyolefin resin (preferably an acid-modified polypropylene resin) or an acid-modified olefin-styrene copolymer resin as a main component.

As shown in FIG. 2, when the window assembly 1 is attached to a window opening edge 9 of a body to be attached (made of a body panel of the car in this embodiment), the projection portion 24 comes in elastic pressure contact with the window opening edge 9 so that a space between the end surface 10c of the window pane 10 and the window opening edge 9 is concealed. Incidentally, the reference numeral 41 in FIG. 1 designates an attaching position of a fixture for fixedly positioning the window assembly 1. The window assembly 1 can be positioned by locking the fixture into a positioning hole, etc., formed in the car body panel. The reference numeral 44 in FIG. 2 designates a sealant 44 also serving as adhesive (provided on the whole circumference of the window assembly 1). The sealant 44 bonds the window assembly 1 and the window opening edge 9, and has a paste-like form to secure sealing therebetween. The sealant 44 exhibits elasticity like rubber when the sealant 44 is cured. The reference numeral 46 in FIG. 2 designates a so-called dam rubber (provided on the whole circumference of the window assembly 1) for suppressing protrusion of the sealant 44.

The window assembly 1 thus configured can be manufactured, for example, in the following steps, using the window pane 10 including the end surface 10C roughened by grinding and the frit layer 12.

Step 1: This is a step of degreasing the peripheral edge portion of the window pane. That is, at least an area of the peripheral edge portion of the window pane 10 where the adhesive layer 30 will be disposed is cleaned (degreased). For example, the area is wiped with lower alcohol. In this manner, oil, dust, dirt, etc., are removed from the area.

Step 2: This is a step of forming an adhesive layer. That is, an adhesive layer 30 is formed in the cleaned peripheral edge portion. For example, an adhesive agent obtained by dissolving or dispersing an acid-modified polypropylene resin in a suitable solvent (e.g. a solvent including toluene as a main component) is applied to a predetermined area of the window pane 10 (the portion where the concealing member 20 will be formed) by a brush, etc.

Step 3: This is a step of drying the adhesive layer. That is, the adhesive layer (applied adhesive agent) 30 is dried (preferably air-dried) so as to volatilize at least a part (preferably a large part) of the solvent contained in the adhesive agent.

Step 4: This is a step of heating the window pane. That is, the window pane 10 with the adhesive layer 30 thereon is heated so that at least the peripheral edge portion 100 is put in a temperature range higher than normal temperature (e.g. 25° C.). The heating temperature on this occasion can be set, for example, in a range not lower than about 50° C. (typically in a range of about 50-130° C.), preferably in a range not lower than about 60° C. (typically in a range of about 60-120° C.), more preferably in a range not lower than about 80° C. (typically in a range of about 80-120° C.). The window pane 10 as a whole may be heated to a temperature higher than normal temperature. The step 3 may be performed simultaneously with the step 4.

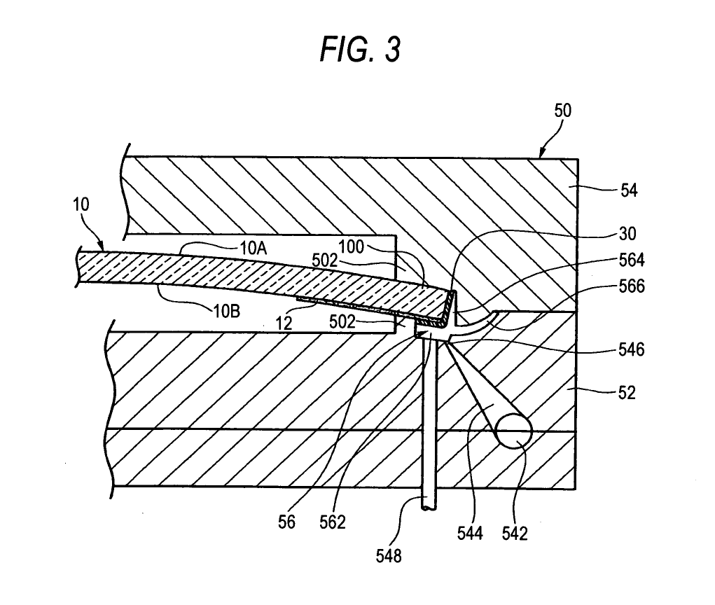

Step 5: This is a step of setting the window pane in an injection mold. That is, the window pane 10 having the adhesive layer 30 formed thereon in advance is set in an injection mold 50 as shown in FIG. 3. The injection mold 50 has a core mold part (lower mold part) 52 and a cavity mold part (upper mold part) 54. The injection mold 50 is opened and the window pane 10 is then disposed therein. Incidentally, when the step 4 is omitted, the window pane 10 may be heated in the injection mold 50 opened and having the window pane 10 disposed therein.

Step 6: This is a step of closing the mold and forming a concealing member forming cavity. That is, when the mold 50 is closed (clamped) as shown in FIG. 3, a cavity 56 shaped correspondingly to the shape of the concealing member 20 is defined and formed by mold surfaces of the core and cavity mold parts 52 and 54 and the peripheral edge portion 100 of the window pane 10. In particular, the cavity 56 includes a bottom portion forming cavity 562 shaped correspondingly to a bottom portion 222 of the base portion 22 of the concealing member 20 (see FIG. 2), a side portion forming cavity 564 shaped correspondingly to a side portion 224 of the base portion 22, and a projection portion forming cavity 566 shaped correspondingly to the projection portion 24 of the concealing member 20. By means of the mold clamping, the window pane 10 is fixed in the condition in which at least a part of the peripheral edge portion 100 of the window pane 10 is exposed in the cavity 56. In the mold 50 shown in FIG. 3, the reference numeral 502 designates a portion functioning as a window pane pressing and sealing portion on this condition.

Step 7: This is a step of filling the cavity with a heated and molten forming material (mainly containing a TPO resin) by injection. That is, the cavity 56 is filled with the heated and molten concealing member forming material by injection under a predetermined injection pressure (normally, preferably set at about 200-1,000 kgf/cm2, that is, about 20-100 MPa) through a runner 542, a sprue 544 and an injection gate 546 provided in the cavity mold part 54. Accordingly, the concealing member forming material heated and molten is brought into pressure contact with the window pane 10 through the adhesive layer 30. Although the injection molding temperature on this occasion varies according to the kind of TPO used, or the like, the appropriate injection molding temperature is normally set to be in a range of about 170-230° C. By the heat of the forming material fed to the cavity 56 and the injection pressure, the concealing member 20 having a sectional shape shown in FIG. 2 is formed and integrally bonded to the peripheral edge portion 100 of the window pane 10 through the adhesive layer 30.

Step 8: This is a step of cooling the injected forming material (resin). At least the surface of the injected forming material is cooled down to a (solidifying) temperature lower than its melting temperature. Preferably, the whole of the injected forming material is cooled down to a temperature substantially lower than the melting temperature (more preferably, down to a temperature lower than its thermal deformation temperature). On this occasion, the forming material having an amount enough to compensate for volume shrinkage due to cooling may be successively supplied to the cavity 56 (to thereby keep the pressure).

Step 9: This is a step of opening the mold and extracting the window assembly therefrom. That is, the injection mold 50 is opened so that the window assembly 1 is extracted from the mold 50 using an ejector pin 548. In this manner, the window assembly 1 in which the concealing member 20 is integrally bonded to the peripheral edge portion 100 of the window pane 10 can be manufactured. In the concealing member 20, the base portion 22 and the projection portion 24 are integrally injection-molded out of one and the same concealing member forming material.

Incidentally, in the manufacturing method thus described by way of example, manufacturing steps other than Steps 1 to 9 may be added if necessary. One or more steps of Steps 1 to 9 may be omitted or may be combined with another step. Examples of steps suitable to be omitted may include Step 1, Step 3 and Step 4.

According to the manufacturing method, when the forming material is injected in the state in which at least the peripheral edge portion 100 of the window pane 10 is heated. In such a manner, the temperature of the injected forming material is prevented from dropping suddenly. Thus, the forming material can be prevented from being solidified suddenly. Accordingly, the cavity 56 in every corner (e.g. in respective portions designated by the reference numerals 562, 564 and 566) can be filled with the forming material appropriately without giving any excessive flow resistance to the forming material and without needing any excessive injection pressure. Consequently, pressure (injection pressure) required for injection of the forming material can be reduced so that the material pressure applied to the window pane 10 can be reduced. Therefore, the window pane 10 can be prevented from being damaged when the forming material is injected, and the window pane 10 can be prevented from being shifted (displaced) in the mold due to the injection pressure of the forming material. Force of clamping the window pane 10 at the time of mold clamping can be also reduced so that the window pane can be prevented from being damaged at the time of the mold clamping, etc. According to the manufacturing method, at least one of these effects can be attained.

Although the embodiment has been described about the window assembly having a concealing member formed from a concealing member forming material mainly containing TPO, the invention is also applicable to a window assembly having a concealing member formed from a concealing member forming material mainly containing TPS (preferably SBC). In this case, an adhesive layer containing an acid-modified olefin-styrene copolymer resin as a main component is preferably used as the adhesive layer.

Although the embodiment has been described on the case where the adhesive layer 30 is provided only in the area where the concealing member 20 will be formed (the area where the base portion 22 will be bonded), the area where the adhesive layer 30 is provided is not limited thereto. For example, the adhesive layer 30 may be provided in an area including the aforementioned area but slightly larger than the aforementioned area in consideration of a manufacturing error. Alternatively, the adhesive layer 30 may be provided in a part of the aforementioned area. In addition, the adhesive layer 30 may be provided continuously in the longitudinal direction as in the embodiment, or may be provided intermittently (e.g. in the form of stripes).

### SECOND EMBODIMENT

In a second embodiment, a window assembly is manufactured with a configuration in which during injection molding of a concealing member, a part of an injected material is fluidized to make it possible to bond a fixture such as an attachment clip to the rear surface of a window pane. Members having the same functions as those of the members in the first embodiment are denoted by the same reference numerals correspondingly and description of these members will be omitted.

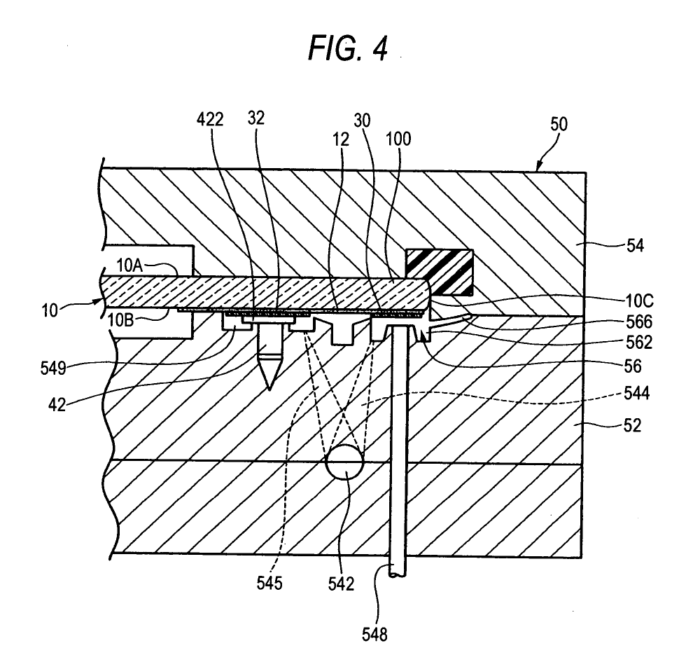

As shown in FIG. 4, in a window pane 10, adhesive layers 30 and 32 are formed in advance on the portion of the window pane rear surface 10B where a concealing member 20 will be formed and the portion of the window pane rear surface 10B where a fixture 42 will be fixedly attached, in the same manner as in the first embodiment. When an injection mold 50 is opened, the fixture 42 is set in a predetermined position in the mold 50 (core mold part 52) and the window pane 10 is then set. When the mold 50 is closed, a cavity 56 is formed. A forming material heated and molten is injected into the cavity 56 through a runner 542 and a sprue 544. On this occasion, a retention portion forming cavity 549 is filled with the heated and molten forming material by injection through another sprue 545 connected to the runner 542. In this manner, a retention portion for fixing a base portion 422 of the fixture 42 to the window pane 10 can be formed and bonded to the window pane rear surface 10B through the adhesive layer 32. The retention portion (formed into a shape corresponding to the retention portion forming cavity 549 shown in FIG. 4) retains the base portion 422 of the fixture 42. As a result, the fixture 42 can be fixed to a predetermined position on the frit layer 12 in the window pane rear surface 10B. When the window assembly 1 is attached to a car body panel, etc., the fixture 42 is locked into a positioning hole, etc., of an opening portion of a car body so as to serve to position the window pane 1. Incidentally, in the window pane according to the embodiment, the base portion of the concealing member 20 is formed to cover substantially only the rear surface 10B side of a peripheral edge portion 100 of the window pane 10.

Incidentally, when a gap is retained for preventing the base portion 422 of the fixture 42 from coming into direct contact with the window pane rear surface 10B, the forming material going into the gap is solidified. Accordingly, a variety of direction can be given to the fixture 42.

### THIRD EMBODIMENT

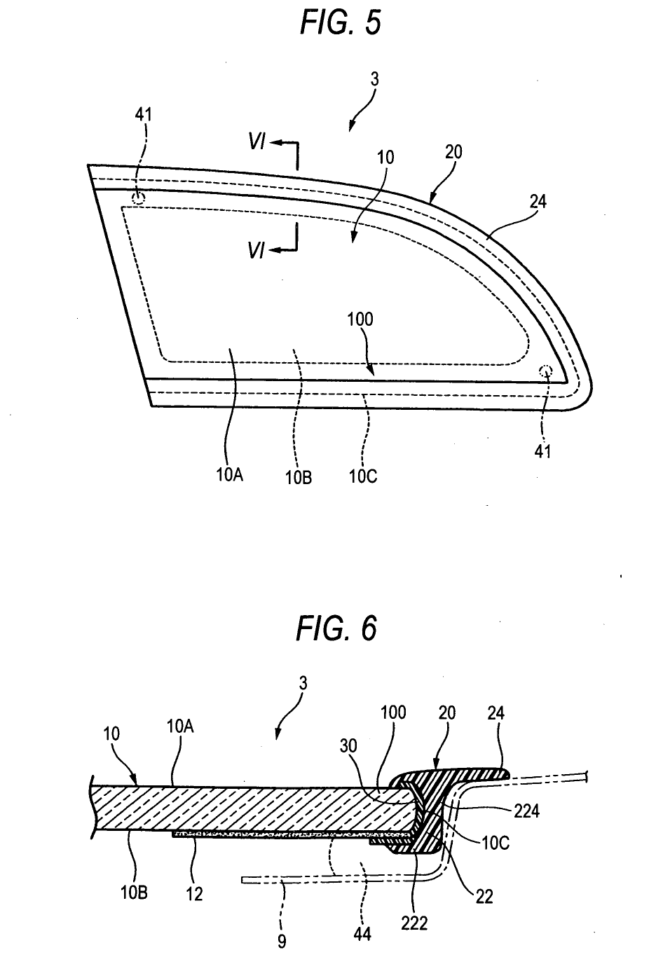

In a third embodiment, the invention is applied to a vehicle quarter window (such as a rear quarter glass window of a passenger car or a van, or a glass window in a luggage compartment side surface of a station wagon) by way of example. As shown in FIGS. 5 and 6, in a window assembly 3 according to the embodiment, a base portion 22 of a concealing member 20 is formed continuously in an area ranging from a rear surface 10B of a peripheral edge portion 100 of a window pane 10 to a front surface 10A thereof via an end surface 10C thereof. The base portion 22 is bonded to the window pane 10 through an adhesive layer 30 provided in advance (before the concealing member 20 is formed), in the same manner as in the aforementioned embodiments. The window assembly 3 thus configured is attached so that a thin and elastic projection portion 24 of the concealing member 20 is brought into elastic contact with a car body panel constituting a window opening edge 9 of a body to be attached (a car in this embodiment) from the outside.

### EXAMPLE

Examination on adhesion between a window pane and a concealing member was made while a material used and injection molding conditions were changed. As a test piece, a window pane mainly constituted by a glass plate 3 mm thick, 120 mm long and 25 mm wide was used. One surface (rear surface) of the glass plate was roughened by a frit layer (roughened layer) formed all over the surface. The other surface (front surface) of the glass plate remained a (smooth) glass surface lower in roughness than the rear surface of the glass plate. In either the front surface or the rear surface of the test piece, an adhesive layer was formed in an area ranging from one end to the vicinity of the center in the longitudinal direction (area about 60 mm long). As an adhesive agent for use in formation of the adhesive layer, “Surflen (registered trademark) P-1000” (hereinafter referred to as “adhesive (A)”) and “Surflen AP-343” (hereinafter referred to as “adhesive (B)”) available from Mitsubishi Chemical Corp. were used.

A forming material was injected on the adhesive-layer-formed surface of the test piece so that a plate-like molded piece (corresponding to the concealing member in the window assembly) was formed thereon. As the forming material, a forming material (hereinafter referred to as “forming material (1)”) mainly containing “Milastomer (registered trademark) S650B” which was TPO available from Mitsui Chemicals, Inc., a forming material (hereinafter referred to as “forming material (2)”) mainly containing “Sumiflex (trademark) QE503ATB” which was TPS available from Advanced Plastics Compounds Company, a forming material (hereinafter referred to as “forming material (3)”) mainly containing “Thermorun (trademark) QT70SA” which was TPO available from Mitsubishi Chemical Corp. were used. Of them, the forming material (1) has a composition containing 40% of an inorganic filler (talc in this embodiment) by mass relative to the total mass.

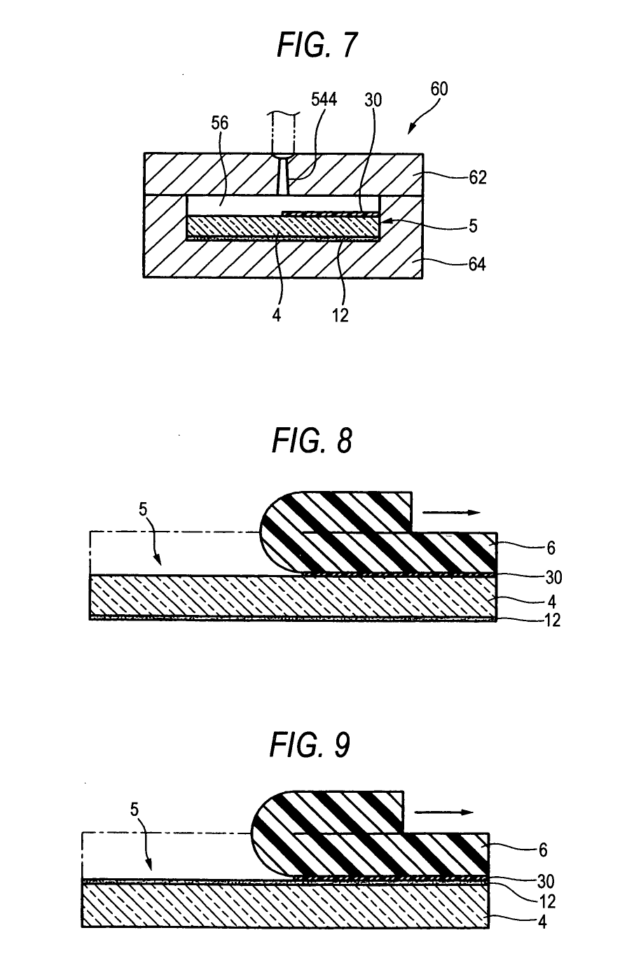

Injection molding is performed as follows. That is, as shown in FIG. 7, an injection mold 60 having an upper mold part 62 and a lower mold part 64 is opened, and a test piece 5 is set in the lower mold piece 64 while the surface (front or rear surface) including the adhesive layer 30 in the test piece 5 is made to face up. FIG. 7 shows the state where the test piece 5 is set while the surface of the test piece 5 where the frit layer 12 is not formed (i.e. the surface where the glass plate 4 is exposed) is made to face up. When the mold 60 is closed, a cavity 56 about 2 mm thick, about 120 mm long and about 25 mm wide is defined and formed by the front surface of the test piece 5 and the cavity surface of the upper mold piece 62. Under the conditions that the temperature of the cylinder of the projection machine is 190° C. and projection pressure is 800 kgf/cm2 (about 78 MPa), a forming material heated and molten is injected through a sprue 544 provided in the upper mold part 62 so that the cavity 56 is filled with the forming material. On this occasion, the test piece 5 is heated properly to a predetermined temperature in an oven before the forming material is injected. Specifically, the forming material is injected while the test piece 5 is set at a temperature of 15° C. (not heated), 60° C. (heated for 15 sec), or 80° C. (heated for 30 sec). After the pressure is kept for 5 sec after the completion of the injection, the mold 60 is cooled and opened. The test piece 5 (sample to be measured) having a plate-like molded piece formed thereon is taken out from the mold 60.

Each obtained sample was put in a normal state, an excess humidity state (kept for 240 hours at a temperature of 50° C. and a humidity of 95%), a heated state (kept for 240 hours at a temperature of 80° C.), an in-water state (kept for 240 hours in water at a temperature of 40° C.), an in-high-temperature-water state (kept for 3 hours in water at a temperature of 80° C.), and a thermal shock state (5 times repeated was a cycle in which the sample was kept for 5 hours at a temperature of 80° C., for 1 hour at room temperature, for 5 hours at a temperature of 30° C., and for 1 hour at room temperature). After that, the adhesive strength of the molded piece to the test piece was measured by a 180° peel test. That is, as shown in each of FIG. 8 (in the case where the plate-like molded piece 6 was formed on the surface not provided with the frit layer) and FIG. 9 (in the case where the plate-like molded piece 6 was formed on the surface provided with the frit layer), a plate-like molded piece 6 formed on the test piece 5 in the area where the adhesive layer 30 was not formed was folded back and pulled in the direction of 180° (in the arrow direction shown in each of FIGS. 8 and 9). In this manner, the 180° peel strength of the molded piece 6 formed on the adhesive layer 30 was measured. Results of the measurement are shown in Table 1. Incidentally, the unit of each measured value in Table 1 is “kgf/25 mm width”. When each value in Table 1 is multiplied by 9.8, the value can be expressed on a basis of “N/25 mm width” which is an SI unit. The mark “*” in front of each measured value means the fact that the base material was broken (that is, not the adhesive interface but the inside of the molded piece was broken). Each blank shown in the table means the fact that measurement was not carried out on the condition or the fact that the number of times of measurement (number n of samples) was smaller than 3.

TABLE 1

| | | | Existence of | | | | | | | | | |
|---|---|---|---|---|---|---|---|---|---|---|---|---|
| Forming | Adhesive | | Roughened | Normal | | | Excess Humidity | | | Heated | | |
| Material | Agent | Heating | Layer | State | | | State | | | State | | |
| (1) | (A) | None | No | 20 | 13 | | 6 | 9 | 6 | 18 | 13 | 15 |
| | | (15° C.) | Yes | 28 | 12 | | 10 | 12 | 10 | 14 | 16 | 16 |
| | | 30 sec | No | 11 | 58 | 64 | 56 | 12 | 58 | 33 | | |
| | | (60° C.) | Yes | 26 | 22 | 52 | 56 | 60 | 50 | 28 | 50 | 40 |
| | | 60 sec | No | 67 | 54 | 64 | 65 | 17 | 70 | 32 | 36 | |
| | | (80° C.) | Yes | 77 | 65 | 67 | 58 | 62 | 66 | 53 | 30 | 49 |
| | (B) | None | No | 18 | | | | | | 96 | 55 | 120 |
| | | (15° C.) | Yes | 79 | 64 | | 67 | 66 | 66 | *135 | 96 | *143 |
| | | 30 sec | No | 59 | *139 | | 39 | | | *108 | 105 | *111 |
| | | (60° C.) | Yes | *138 | | | *144 | *130 | 143 | 147 | 146 | |
| | | 60 sec | No | 89 | *138 | | 70 | | | *132 | 45 | *135 |
| | | (80° C.) | Yes | *138 | *143 | *130 | *143 | *143 | *143 | *141 | *141 | *136 |
| (2) | (A) | None | No | 2 | 9 | | 12 | 9 | | 6 | 9 | 32 |
| | | (15° C.) | Yes | 60 | | | 42 | 33 | 34 | 38 | 34 | 34 |
| | (B) | 30 sec | No | *174 | 64 | | 58 | | | *175 | *176 | *148 |
| | | (60° C.) | Yes | *172 | *177 | | 116 | *169 | *169 | *170 | *182 | *199 |
| (3) | (A) | None | No | 65 | 47 | | 32 | 27 | | 41 | 16 | 30 |
| | | (15° C.) | Yes | 55 | 68 | | 22 | 35 | 48 | 50 | 39 | 27 |
| | (B) | 30 sec | No | 8 | 20 | 26 | | | | 88 | 85 | 92 |
| | | (60° C.) | Yes | 64 | 90 | 82 | 47 | 32 | | 106 | 106 | 109 |
| | | | Existence of | | | | In-High- | | | | | |
| Forming | Adhesive | | Roughened | In-Water | | | Temperature- | | | Thermal Shock | | |
| Material | Agent | Heating | Layer | State | | | Water State | | | State | | |
| (1) | (A) | None | No | 14 | 8 | | 19 | | | 6 | 4 | 2 |
| | | (15° C.) | Yes | 17 | 12 | 14 | 9 | 11 | 15 | 6 | 10 | 10 |
| | | 30 sec | No | 54 | 30 | | | | | 13 | 14 | |
| | | (60° C.) | Yes | 64 | 59 | 60 | 47 | 39 | 47 | 25 | 29 | |
| | | 60 sec | No | 69 | 68 | 64 | | | | 38 | 44 | 13 |
| | | (80° C.) | Yes | 70 | 73 | 48 | 52 | 52 | 49 | 60 | 20 | 23 |
| | (B) | None | No | | | | 54 | 45 | 45 | 40 | 105 | |
| | | (15° C.) | Yes | 70 | 64 | 65 | 69 | 25 | 58 | 97 | 100 | 75 |
| | | 30 sec | No | 6 | | | 90 | 105 | 120 | *122 | *132 | *95 |
| | | (60° C.) | Yes | *153 | *141 | *133 | *136 | *139 | | *125 | *117 | 126 |
| | | 60 sec | No | 62 | | | *126 | *125 | *126 | 86 | *109 | *109 |
| | | (80° C.) | Yes | *144 | 144 | | *119 | *135 | *141 | *135 | *140 | *140 |
| (2) | (A) | None | No | 10 | 7 | 10 | 12 | | | 26 | 35 | |
| | | (15° C.) | Yes | 50 | 12 | 20 | 68 | 64 | 48 | 56 | 52 | 59 |
| | (B) | 30 sec | No | | | | 94 | 108 | 106 | *142 | 103 | |
| | | (60° C.) | Yes | 166 | *170 | 132 | *160 | *172 | 158 | *165 | 174 | *171 |
| (3) | (A) | None | No | | | | 41 | | | 7 | 40 | 43 |
| | | (15° C.) | Yes | 50 | 48 | 42 | 32 | 42 | 37 | 48 | 38 | 52 |
| | (B) | 30 sec | No | | | | 9 | 10 | | 78 | 62 | |
| | | (60° C.) | Yes | 20 | 45 | | 69 | 68 | 55 | 104 | 106 | |

According to the results shown in Table 1, it is proved that the molded piece can be bonded to the test piece when any forming material used herein is combined with any adhesive agent used herein. It is also proved that to provide the roughened layer (frit layer 12) and to inject the forming material in the state in which the test piece is heated to a temperature range higher than normal temperature are effective in obtaining a better bonded product (corresponding to the window assembly). It is also proved that a further better bonded product can be obtained when the roughened layer is formed while the test piece is heated. Good results could be obtained particularly in the combination of the forming material (1) and the adhesive agent (B) and the combination of the forming material (2) and the adhesive agent (B).

Although specific embodiments of the invention have been described above in detail, these specific examples are simply for illustration but not intended to limit the scope of claims. The technique described in the scope of claims may include modifications and changes variously made on the illustrated specific embodiments.

For example, although the first embodiment has been described on the method for manufacturing a back window of a car by way of example, the invention is also applicable to a front window of a car. In this case, when the window pane is a laminate glass including a transparent intermediate layer, it is preferable that the highest temperature for heating the window pane is set at about 110° in order to prevent thermal deterioration of the intermediate layer.

Each technical element described in the specification or the drawings exerts technical availability when it is used along or in various combinations of other elements, but the combinations are not limited to the combinations described in the appended claims. The technique described in the specification or the drawings can simultaneously achieve several objects. In addition, the technique is to have technical availability only if it attains one of the objects.

1. A window assembly to be attached to a window opening edge of a body to be attached, comprising:
an inorganic glass window pane having a front surface and a rear surface;
a concealing member formed integrally with the window pane along a peripheral edge of the window pane for concealing between the peripheral edge of the window pane and the window opening edge; and
an adhesive layer containing one of an acid-modified polyolefin resin and an acid-modified olefin-styrene copolymer resin as a main component and formed in the peripheral edge of the window pane and in a portion where the concealing member is formed;
wherein the concealing member comprises:
a base portion formed from a base portion forming material mainly containing one of an olefin-based thermoplastic elastomer material and a styrene-based thermoplastic elastomer material, in such a manner that the base portion forming material heated and molten is pressed against the window pane so as to be bonded to the window pane through the adhesive layer, and the base portion forming material is cooled and solidified; and
a projection portion formed from a projection portion forming material mainly containing a thermoplastic elastomer material, the projection portion being formed integrally with the base portion so as to protrude from the base portion toward the window opening edge, the projection portion being elastically deformed and brought into elastic contact with the window opening edge when the window assembly is attached to the window opening edge in a predetermined position.

2. The window assembly according to claim 1, wherein a roughened layer having a surface rougher than the front surface of the window pane is formed in at least a peripheral edge of the rear surface of the window pane, at least a part of the adhesive layer is formed on the roughened layer, and the base portion of the concealing member is bonded to the window pane through the adhesive layer.

3. The window assembly according to claim 1, wherein at least a part of an end surface of the window pane is roughened by grinding, the adhesive layer is formed in a portion including the roughened end surface, and the base portion of the concealing member is bonded to the window pane through the adhesive layer.

4. The window assembly according to claim 1, wherein the base portion forming material further contains an inorganic filler.

5. The window assembly according to claim 1, wherein a periphery of the window pane has linear portions and corner portions, the concealing member is formed continuously in an area covering the linear portions and the corner portions, and the concealing member is formed into such a shape that the projection portion is more displaced toward a surface center of the window pane in the corner portions than in the linear portions.

6. The window assembly according to claim 1, wherein the acid-modified polyolefin resin is a carboxyl-modified polyolefin resin or an acrylic-modified polyolefin resin.

7. The window assembly according to claim 1, wherein the acid-modified olefin-styrene copolymer resin is a carboxyl-modified olefin-styrene copolymer resin or an acrylic-modified olefin-styrene copolymer resin.

8. A method for manufacturing a window assembly including an inorganic glass window pane and a concealing member formed along a peripheral edge of the window pane, comprising the steps of:
preparing the window pane in which an adhesive layer containing one of an acid-modified polyolefin resin and an acid-modified olefin-styrene copolymer resin as a main component is formed in a portion where the concealing member is formed;
setting the window pane including the adhesive layer in an injection mold;
closing the mold so that the window pane is fixed in the mold with the peripheral edge of the window pane being at least partially exposed in a cavity of the mold, and forming the cavity corresponding to a shape of the concealing member in the inside of the mold;
filling the cavity with a forming material by injection through an injection gate of the mold under a predetermined injection pressure while the forming material mainly containing one of an olefin-based thermoplastic elastomer material and a styrene-based thermoplastic elastomer material is heated and molten, so that the concealing member is formed and bonded to the window pane through the adhesive layer; and
cooling and solidifying the forming material, and opening the mold so as to extract the window assembly from the mold, the window assembly having the concealing member integrally bonded to the peripheral edge of the window pane.

9. A method for manufacturing a window assembly including an inorganic glass window pane and a concealing member formed along a peripheral edge of the window pane, comprising the steps of:
forming an adhesive layer on at least a portion of the window pane where the concealing member is formed, the adhesive layer containing one of an acid-modified polyolefin resin and an acid-modified olefin-styrene copolymer resin as a main component;
setting the window pane including the adhesive layer in an injection mold;
closing the mold so that the window pane is fixed in the mold with the peripheral edge of the window pane being at least partially exposed in a cavity of the mold, and forming the cavity corresponding to a shape of the concealing member in the inside of the mold;
heating and melting a forming material mainly containing one of an olefin-based thermoplastic elastomer material and a styrene-based thermoplastic elastomer material, and filling the cavity with the molten forming material by injection through an injection gate of the mold under a predetermined injection pressure so as to form the concealing member and bond the concealing member to the window pane through the adhesive layer; and
cooling and solidifying the forming material, and opening the mold so as to extract the window assembly from the mold, the window assembly having the concealing member integrally bonded to the peripheral edge of the window pane.

10. The manufacturing method according to claim 8, wherein a roughened layer having a surface rougher than a front surface of the window pane is formed in a peripheral edge of a rear surface of the window pane, and the adhesive layer is formed on the roughened layer.

11. The manufacturing method according to claim 9, wherein a roughened layer having a surface rougher than a front surface of the window pane is formed in a peripheral edge of a rear surface of the window pane, and the adhesive layer is formed on the roughened layer.

12. The manufacturing method according to claim 8, wherein the adhesive layer is formed from an adhesive agent containing one of an acid-modified polyolefin resin and an acid-modified olefin-styrene copolymer resin as a main component and applied onto at least one of (a) a periphery of one of surfaces of the window pane and an end surface of the window pane and (b) a periphery of the other surface of the window pane, and the concealing member is formed on the adhesive layer formed on one of the surfaces.

13. The manufacturing method according to claim 9, wherein the adhesive layer is formed from an adhesive agent containing one of an acid-modified polyolefin resin and an acid-modified olefin-styrene copolymer resin as a main component and applied onto at least one of (a) a periphery of one of surfaces of the window pane and an end surface of the window pane and (b) a periphery of the other surface of the window pane, and the concealing member is formed on the adhesive layer formed on one of the surfaces.

14. The manufacturing method according to claim 8, wherein the forming material is injected while at least the peripheral edge of the window pane set in the mold is heated to a temperature range higher than normal temperature.

15. The manufacturing method according to claim 9, wherein the forming material is injected while at least the peripheral edge of the window pane set in the mold is heated to a temperature range higher than normal temperature.

16. The manufacturing method according to claim 14, wherein the concealing member is bonded to the window pane while the window pane as a whole is heated to a temperature range higher than normal temperature.

17. The manufacturing method according to claim 15, wherein the concealing member is bonded to the window pane while the window pane as a whole is heated to a temperature range higher than normal temperature.
